(19) United States
(12) Patent Application Publication
(10) Pub. No.: US 2026/0187949 A1
(43) Pub. Date: Jul. 2, 2026

(54) MULTI-VIEW CONSISTENCY USING GLOBAL-SPACE NORMALS

(71) Applicant: Snap Inc., Santa Monica (CA)

(72) Inventors: Sergei Korolev, Playa Vista, CA (US); Vladislav Shakhrai, Los Angeles, CA (US)

(21) Appl. No.: 19/005,317

(22) Filed: Dec. 30, 2024

(51) Int. Cl. G06T 19/20; G06T 15/04; G06T 17/20

(52) U.S. Cl. CPC G06T 19/20; G06T 15/04; G06T 17/20; G06T 2219/2004

(57) ABSTRACT

An eXtended Reality (XR) content creation environment is provided. A machine learning model is trained by receiving a set of three-dimensional (3D) assets. The training process includes an alignment filter component that generates aligned 3D assets by orienting each 3D asset to face a consistent predefined direction in global-space. A renderer generates multiview global-space normal maps that maintain consistent orientation independently of camera position for the aligned 3D assets. The renderer also generates corresponding renders that serve as ground truth data. The machine learning model is trained using the global-space normal maps and prompts as conditioning input while using the renders as ground truth, with loss backpropagation applied between generated output textures and the ground truth renders.

### TECHNICAL FIELD

The present disclosure relates generally to user interfaces and, more particularly to user interfaces, used for extended reality.

### BACKGROUND

Development platforms enable creators to generate three-dimensional (3D) content for eXtended Reality (XR) systems through specialized tools and features. These development platforms provide capabilities for creating and texturing 3D assets that can be rendered and displayed on various XR devices, including head-wearable apparatuses and handheld devices. The platforms use rendering techniques to generate high-quality 3D assets from text prompts or image inputs, allowing creators to produce detailed textures and consistent geometric representations across multiple views. Such development platforms enable creation of immersive XR experiences by enabling the generation of 3D assets with proper texturing and geometric consistency that can be effectively displayed across different XR viewing contexts.

### BRIEF DESCRIPTION OF THE SEVERAL VIEWS OF THE DRAWINGS

In the drawings, which are not necessarily drawn to scale, like numerals may describe similar components in different views. To easily identify the discussion of any particular element or act, the most significant digit or digits in a reference number refer to the figure number in which that element is first introduced. Some non-limiting examples are illustrated in the figures of the accompanying drawings in which:

FIG. 1 is a diagram of a content creation system, in accordance with some examples.

FIG. 2 is a block diagram showing a software architecture, in accordance with some examples.

FIG. 3 is a diagrammatic representation of a machine in the form of a computer system within which a set of instructions may be executed to cause the machine to perform any one or more of the methodologies discussed herein, in accordance with some examples.

FIG. 4A illustrates example camera-space camera-normal maps that represent normal vectors in camera space, according to some examples.

FIG. 4B illustrates example textures generated using camera-space normal maps, according to some examples.

FIG. 5A illustrates example multiview global-space normal maps, according to some examples.

FIG. 5B illustrates example textures generated using global-space normal maps, according to some examples.

FIG. 6A illustrates a machine model training method, according to some examples.

FIG. 6B illustrates a machine learning model training pipeline, according to some examples.

FIG. 7 illustrates a texture generation pipeline 130 for generating textures using a machine learning model trained using global-space normal maps, according to some examples.

### DETAILED DESCRIPTION

In computer-generated 3D asset creation, conventional texture generation methods using camera-space normal maps produce inconsistent and flawed results, particularly manifesting as the “Janus problem” where unwanted additional faces appear on the sides and back of 3D objects. This technical limitation stems from camera-space normal maps'inability to properly differentiate between different views of an object, as they represent all frontal views with the same color values regardless of actual orientation. These additional faces cause the 3D assets to be unusable for their intended purposes which wastes resources as the assets need to be recomputed and corrected by human intervention.

The methodologies described herein solve these technical problems by combining global-space normal maps with dataset alignment. Unlike traditional camera-space normal maps, the global-space normal maps maintain consistent orientation regardless of camera position, providing view-independent color distributions that properly differentiate between front, side, and back views. These described methodologies include aligning 3D assets in a training dataset to face consistent directions, then using these aligned assets to train a machine learning model conditioned on the global-space normals. This combination enables the generation of high-quality, consistent textures across all views while eliminating the Janus problem that has plagued existing solutions.

In some examples, a renderer generates renders that serve as ground truth data for training a machine learning model. The renders comprise two-dimensional visual representations of the 3D assets that include geometric features, textures, and lighting information. The renderer generates these renders from the same predefined viewing angles as the multiview global-space normal maps to ensure proper correspondence between the conditioning input and the target output. When generating the renders, a content creation platform processes the 3D asset data to create high-quality renders that accurately capture the geometric and textural details that will be used as reference images during the training process. The renders can be generated in various color spaces such as Linear-sRGB, CIELAB (Lab*), CIELUV, OpenEXR, scRGB, normal map space, bump map space, specular map space, ambient occlusion map space, albedo map space, metalness map space, roughness map space, and HDR color spaces. These renders serve as the ground truth that the machine learning model learns to reproduce when conditioned on the global-space normal maps, enabling the model to generate textures that properly reflect the intended appearance of the three-dimensional assets across different viewing angles

In some examples, a machine learning model training pipeline receives a set of three-dimensional assets. The machine learning model training pipeline generates aligned 3D assets by orienting each 3D asset to face a predefined direction. A renderer generates multiview global-space normal maps that maintain consistent orientation independently of camera position for the aligned 3D assets. The renderer also generates corresponding renders that serve as ground truth data. The machine learning model training pipeline trains a machine learning model using the global-space normal maps as conditioning input while using the renders as ground truth, with loss backpropagation applied between generated output textures and the ground truth renders.

In some examples, the multiview global-space normal maps provide view-independent color distributions that differentiate between front, side, and back views of the three-dimensional assets.

In some examples, a set of prompts are used as an additional conditioning input.

In some examples, the set of multiview global-space normal maps provide respective view-independent color distributions that differentiate between front, side, and back views of the set of 3D assets.

In some examples, generating the set of multiview global-space normal maps comprises maintaining normal vector orientations in a canonical coordinate system regardless of camera positioning.

In some examples, generating the multiview global-space normal maps comprises generating the set global-space normal maps for multiple predefined viewing angles of the set of 3D assets.

In some examples, training the machine learning model further comprises comparing the output textures to respective renders of the set of renders to evaluate texture consistency across multiple views.

In some examples, the set of 3D assets comprise mesh models, and wherein the output textures provide consistent feature representation across different viewing angles.

In some examples, the set of renders are generated using a same predefined viewing angle as the multiview global-space normal maps.

In some examples, the trained machine learning model is used to generate textures for new 3D assets using a prompt as conditioning input.

Other technical features may be readily apparent to one skilled in the art from the following figures, descriptions, and claims.

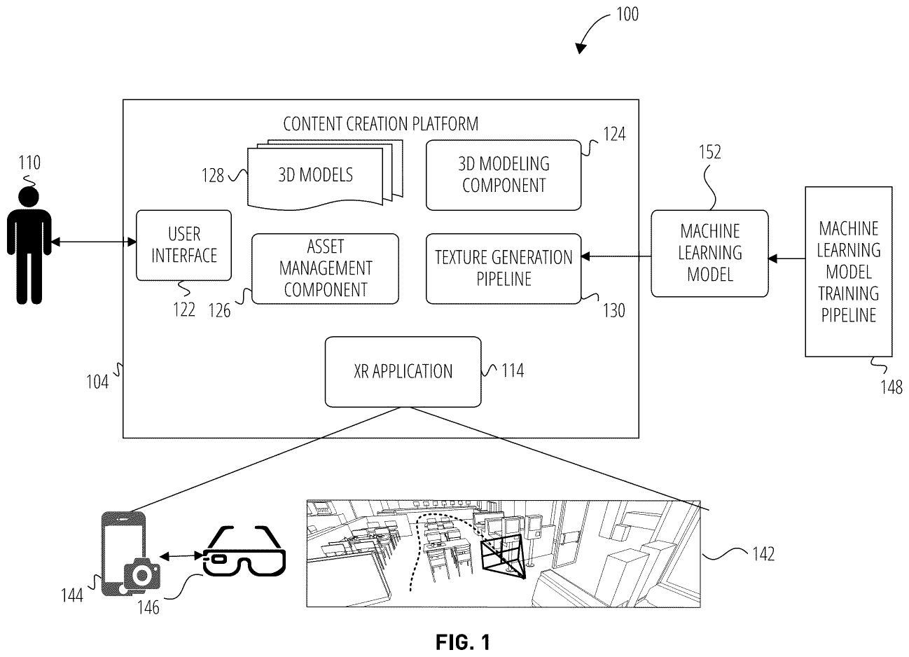

FIG. 1 is a diagram illustrating an XR content creation system 100 for generating content for XR applications, according to some examples. The XR content creation system 100 includes a content creation platform 104. A user 110 uses the content creation platform 104 to create XR content 142 for an XR application 114.

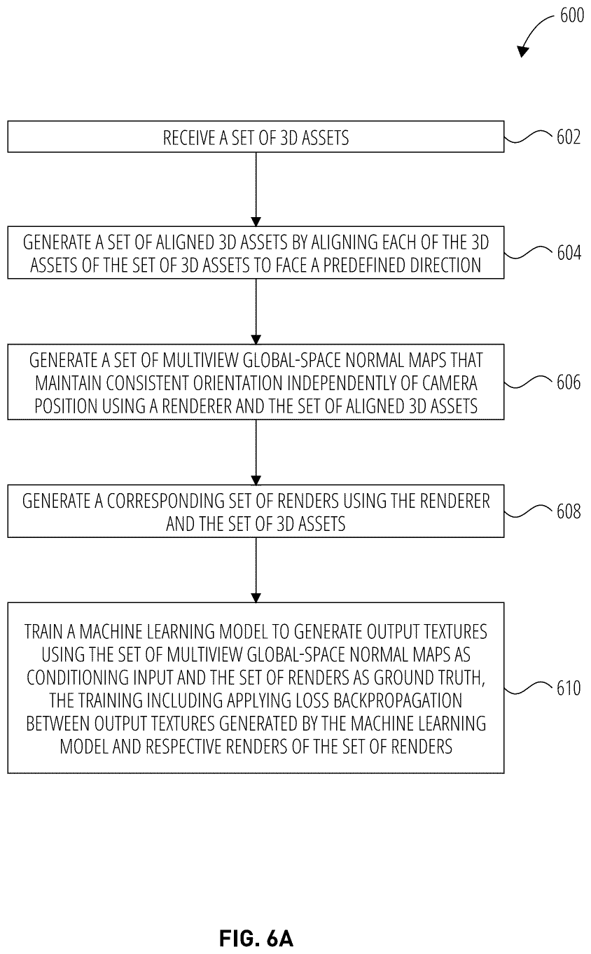

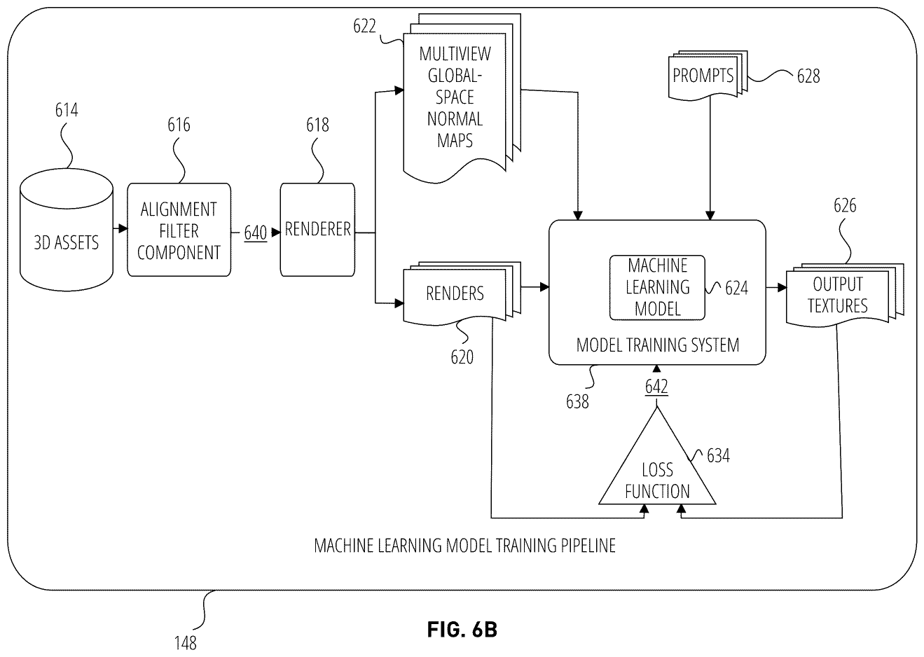

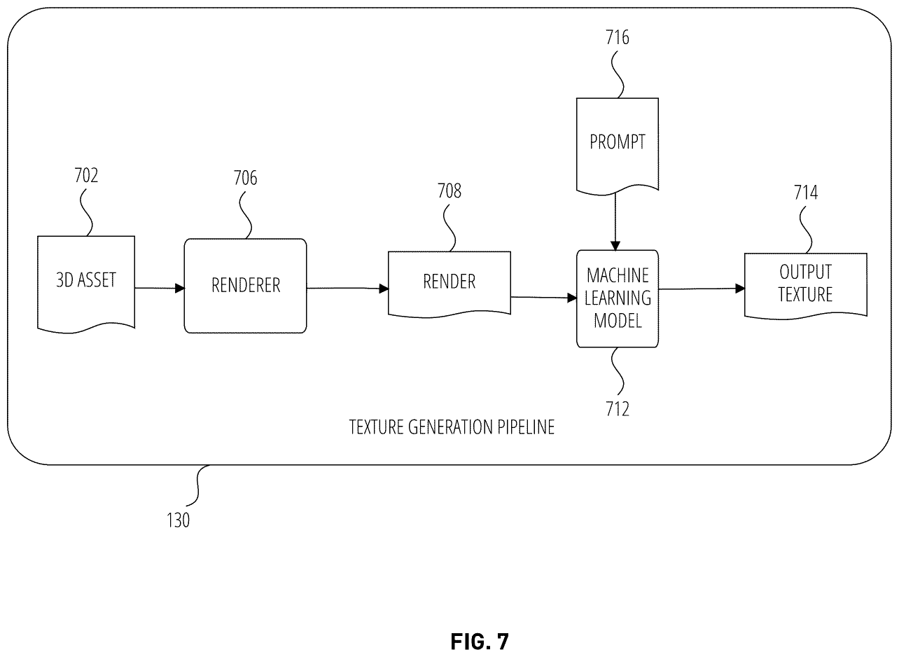

The content creation platform 104 includes a user interface 122, a 3D modeling component 124, an asset management component 126, and 3D models 128. The XR content creation system 100 includes a machine learning model training pipeline 148 that trains a machine learning model 152 using multiview global-space normal maps as more fully described in reference to FIG. 6A and FIG. 6B. The texture generation pipeline 130 uses the machine learning model 152 to generate consistent textures that are used to create 3D XR content 142 as more fully described in reference to FIG. 7.

The user interface 122 provides various graphical user interface (GUI) functions for the content creation platform 104. The user interface 122 enables creators to interact with the content creation platform 104 to generate 3D assets with proper texturing and geometric consistency. Through the user interface 122, users can specify desired characteristics of textures through text prompts, image inputs, or audio inputs that are used as conditioning for the machine learning model. The user interface 122 integrates with other components like the 3D modeling component 124 and asset management component 126 to enable creation of immersive XR experiences by facilitating the generation and management of 3D assets that can be effectively displayed across different XR viewing contexts.

The asset management component 126 handles importing, organizing, and preparing 3D assets for the content creation platform 104. The asset management component 126 interfaces with the 3D models 128 to manage various types of 3D assets used for generating content for XR applications. Through integration with other components like the 3D modeling component 124 and user interface 122, the asset management component 126 enables creators to effectively manage and prepare 3D assets that will be used to generate textures with proper geometric consistency. The asset management component 126 facilitates the organization and preparation of 3D assets that will be processed through the texture generation pipeline 130 to create content that can be effectively displayed across different XR viewing contexts.

The 3D modeling component 124 enables creation and modification of three-dimensional assets within the content creation platform 104. The 3D modeling component 124 interfaces with other system elements like the asset management component 126 and texture generation pipeline 130 to generate high-quality 3D assets with proper texturing and geometric consistency. Through integration with the machine learning model 152 conditioned using multiview global-space normal maps, the 3D modeling component 124 helps ensure generated assets maintain consistent features across different viewing angles while avoiding unwanted artifacts like the Janus problem.

The texture generation pipeline 130 processes three-dimensional assets to generate consistent textures using the machine learning model 152 trained using multiview global-space normal maps. The texture generation pipeline 130 receives 3D assets from the content creation platform 104 and uses the trained machine learning model 152 to generate output textures that exhibit proper geometric consistency across different views as more fully described in reference to FIG. 7.

Once developed, the XR application 114 is deployed on various XR devices such as, but not limited to, mobile XR devices 144 and head-wearable apparatuses 146. The content creation platform 104 enables creators to generate high-quality 3D assets with proper texturing and geometric consistency that can be effectively displayed across different XR viewing contexts.

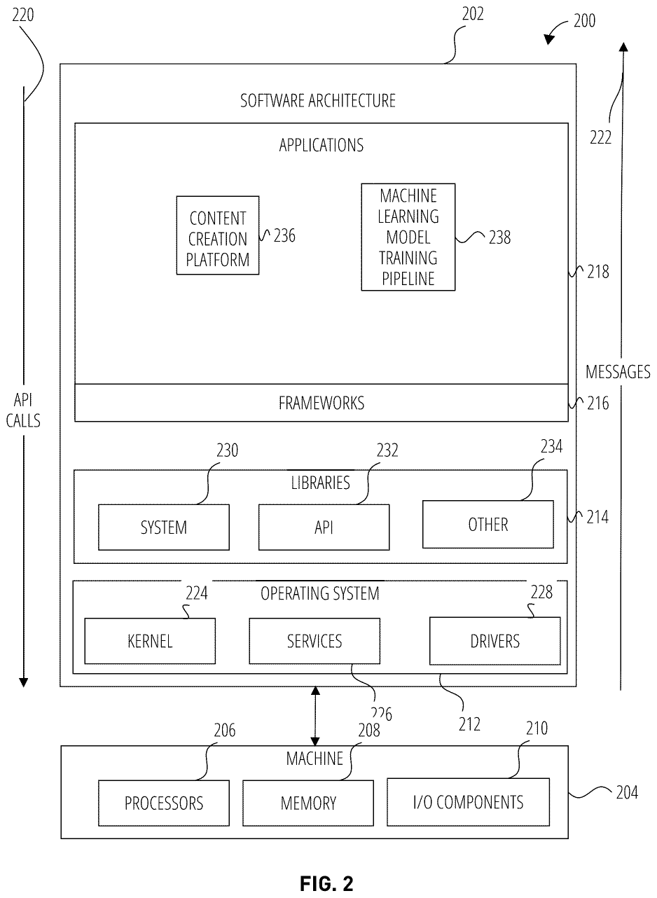

FIG. 2 is a block diagram 200 illustrating a software architecture 202, which can be installed on any one or more of the devices described herein. The software architecture 202 is supported by hardware such as a machine 204 that includes processors 206, memory 208, and I/O components 210. In this example, the software architecture 202 can be conceptualized as a stack of layers, where each layer provides a particular functionality. The software architecture 202 includes layers such as an operating system 212, libraries 214, frameworks 216, and applications 218. Operationally, the applications 218 invoke API calls 220 through the software stack and receive messages 222 in response to the API calls 220.

The operating system 212 manages hardware resources and provides common services. The operating system 212 includes, for example, a kernel 224, services 226, and drivers 228. The kernel 224 acts as an abstraction layer between the hardware and the other software layers. For example, the kernel 224 provides memory management, processor management (e.g., scheduling), component management, networking, and security settings, among other functionalities. The services 226 can provide other common services for the other software layers. The drivers 228 are responsible for controlling or interfacing with the underlying hardware. For instance, the drivers 228 can include display drivers, camera drivers, BLUETOOTH® or BLUETOOTH® Low Energy drivers, flash memory drivers, serial communication drivers (e.g., USB drivers), WI-FI® drivers, audio drivers, power management drivers, and so forth.

The libraries 214 provide a common low-level infrastructure used by the applications 218. The libraries 214 can include system libraries 230 (e.g., C standard library) that provide functions such as memory allocation functions, string manipulation functions, mathematic functions, and the like. In addition, the libraries 214 can include API libraries 232 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic content on a display), database libraries (e.g., SQLite to provide various relational database functions), web libraries (e.g., WebKit to provide web browsing functionality), and the like. The libraries 214 can also include a wide variety of other libraries 234 to provide many other APIs to the applications 218.

The frameworks 216 provide a common high-level infrastructure that is used by the applications 218. For example, the frameworks 216 provide various graphical user interface (GUI) functions, high-level resource management, and high-level location services. The frameworks 216 can provide a broad spectrum of other APIs that can be used by the applications 218, some of which may be specific to a particular operating system or platform.

In some examples, the applications 218 include a content creation platform 236, and a machine learning model training pipeline 238, and a broad assortment of other applications such as a third-party applications. The applications 218 are programs that execute functions defined in the programs. Various programming languages can be employed to create one or more of the applications 218, structured in a variety of manners, such as object-oriented programming languages (e.g., Objective-C, Java, or C++) or procedural programming languages (e.g., C or assembly language).

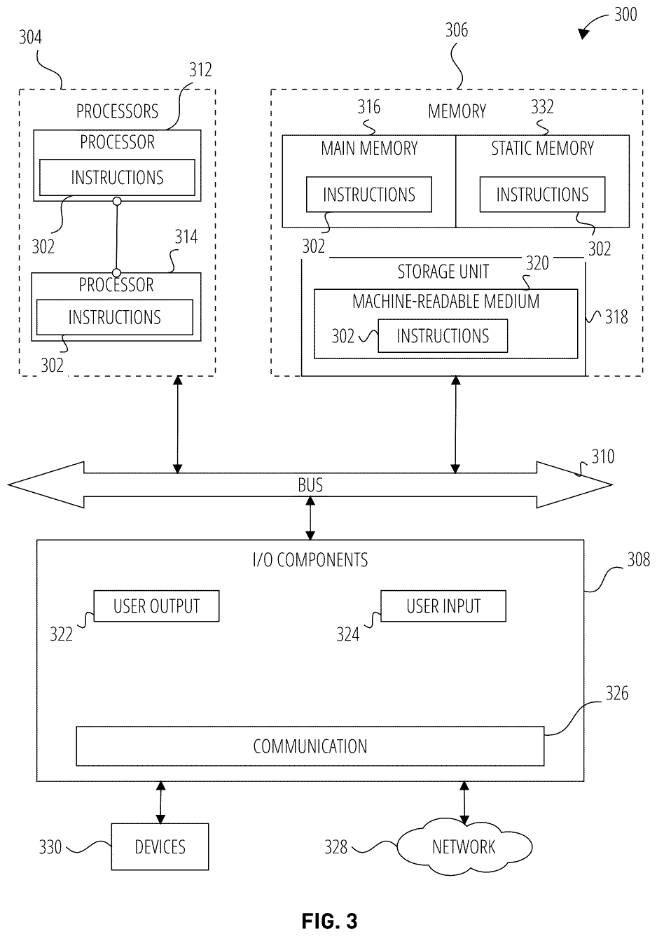

FIG. 3 is a diagrammatic representation of the machine 300 within which instructions 302 (e.g., software, a program, an application, an applet, an app, or other executable code) for causing the machine 300 to perform any one or more of the methodologies discussed herein may be executed. For example, the instructions 302 may cause the machine 300 to execute any one or more of the methods described herein. The instructions 302 transform the general, non-programmed machine 300 into a particular machine 300 programmed to carry out the described and illustrated functions in the manner described. The machine 300 may operate as a standalone device or may be coupled (e.g., networked) to other machines. In a networked deployment, the machine 300 may operate in the capacity of a server machine or a client machine in a server-client network environment, or as a peer machine in a peer-to-peer (or distributed) network environment. The machine 300 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smartphone, a mobile device, a wearable device (e.g., a smartwatch), a smart home device (e.g., a smart appliance), other smart devices, a web appliance, a network router, a network switch, a network bridge, or any machine capable of executing the instructions 302, sequentially or otherwise, that specify actions to be taken by the machine 300. Further, while a single machine 300 is illustrated, the term “machine” shall also be taken to include a collection of machines that individually or jointly execute the instructions 302 to perform any one or more of the methodologies discussed herein. In some examples, the machine 300 may also comprise both client and server systems, with certain operations of a particular method or algorithm being performed on the server-side and with certain operations of the particular method or algorithm being performed on the client-side.

The machine 300 may include processors 304, memory 306, and input/output I/O components 308, which may be configured to communicate with each other via a bus 310. In an example, the processors 304 (e.g., a Central Processing Unit (CPU), a Reduced Instruction Set Computing (RISC) Processor, a Complex Instruction Set Computing (CISC) Processor, a Graphics Processing Unit (GPU), a Digital Signal Processor (DSP), an Application Specific Integrated Circuit (ASIC), a Radio-Frequency Integrated Circuit (RFIC), another processor, or any suitable combination thereof) may include, for example, a processor 312 and a processor 314 that execute the instructions 302. The term “processor” is intended to include multi-core processors that may comprise two or more independent processors (sometimes referred to as “cores”) that may execute instructions contemporaneously. Although FIG. 3 shows multiple processors 304, the machine 300 may include a single processor with a single-core, a single processor with multiple cores (e.g., a multi-core processor), multiple processors with a single core, multiple processors with multiples cores, or any combination thereof.

The memory 306 includes a main memory 316, a static memory 332, and a storage unit 318, both accessible to the processors 304 via the bus 310. The main memory 306, the static memory 332, and storage unit 318 store the instructions 302 embodying any one or more of the methodologies or functions described herein. The instructions 302 may also reside, completely or partially, within the main memory 316, within the static memory 332, within machine-readable medium 320 within the storage unit 318, within at least one of the processors 304 (e.g., within the processor's cache memory), or any suitable combination thereof, during execution thereof by the machine 300.

The I/O components 308 may include a wide variety of components to receive input, provide output, produce output, transmit information, exchange information, capture measurements, and so on. The specific I/O components 308 that are included in a particular machine will depend on the type of machine. For example, portable machines such as mobile phones may include a touch input device or other such input mechanisms, while a headless server machine will likely not include such a touch input device. It will be appreciated that the I/O components 308 may include many other components that are not shown in FIG. 3. In various examples, the I/O components 308 may include user output components 322 and user input components 324. The user output components 322 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The user input components 324 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and force of touches or touch gestures, or other tactile input components), audio input components (e.g., a microphone), and the like.

Communication may be implemented using a wide variety of technologies. The I/O components 308 further include communication components 326 operable to couple the machine 300 to a network 328 or devices 330 via respective coupling or connections. For example, the communication components 326 may include a network interface component or another suitable device to interface with the network 328. In further examples, the communication components 326 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 330 may be another machine or any of a wide variety of peripheral devices (e.g., a peripheral device coupled via a USB).

Moreover, the communication components 326 may detect identifiers or include components operable to detect identifiers. For example, the communication components 326 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 326, such as location via Internet Protocol (IP) geolocation, location via Wi-Fi® signal triangulation, location via detecting an NFC beacon signal that may indicate a particular location, and so forth.

The various memories (e.g., main memory 316, static memory 332, and memory of the processors 304) and storage unit 318 may store one or more sets of instructions and data structures (e.g., software) embodying or used by any one or more of the methodologies or functions described herein. These instructions (e.g., the instructions 302), when executed by processors 304, cause various operations to implement the disclosed examples.

The instructions 302 may be transmitted or received over the network 328, using a transmission medium, via a network interface device (e.g., a network interface component included in the communication components 326) and using any one of several well-known transfer protocols (e.g., hypertext transfer protocol (HTTP)). Similarly, the instructions 302 may be transmitted or received using a transmission medium via a coupling (e.g., a peer-to-peer coupling) to the devices 330.

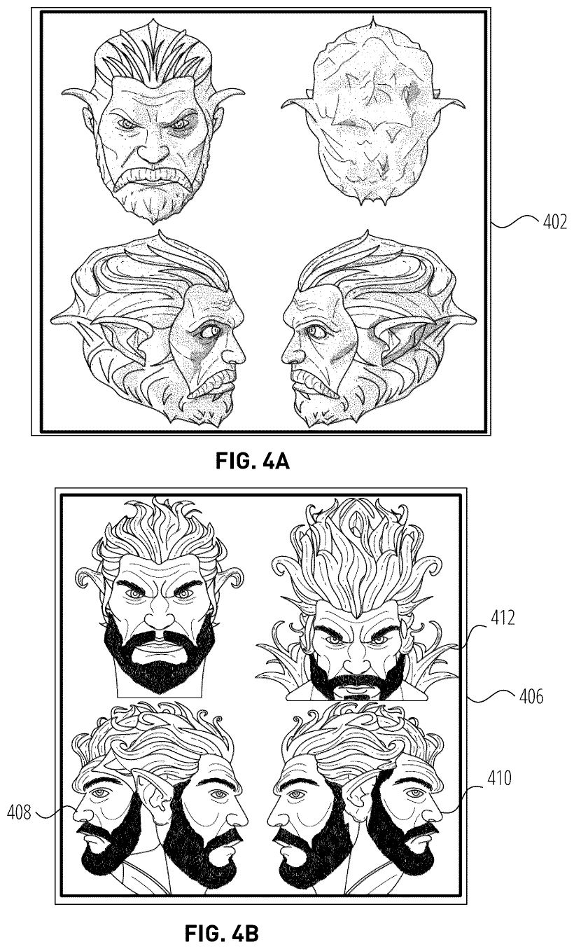

FIG. 4A illustrates example camera-space camera-normal maps 402 that represent normal vectors in camera space, according to some examples. In the camera-normal maps 402, a Z coordinate always points toward a camera. In camera-space normal maps, color values remain constant regardless of an actual orientation of a 3D asset-the frontal parts are represented in blue, the top parts in green, and the right parts in red. This representation fails to properly differentiate between different views of the object, as all frontal views have the same color values regardless of whether they represent the front, side, or back of the 3D asset. This limitation of camera-space normal maps contributes to the Janus problem where unwanted additional faces appear on the sides and back of 3D objects

FIG. 4B illustrates example textures 406 generated using camera-space normal maps, according to some examples. The texture 406 feature unwanted faces 408, 410, and 412 appear on the sides and back of the example texture 406. Because of the limitations of camera-space normal maps failing to properly differentiate between different views, the generated texture 406 exhibit the Janus problem-multiple facial features incorrectly appear on the side and back views of the model instead of showing the appropriate side and back textures. This results in inconsistent and flawed texture generation where forward facing features are duplicated or appear in incorrect orientations across the different views of a 3D model rendered using the texture 406.

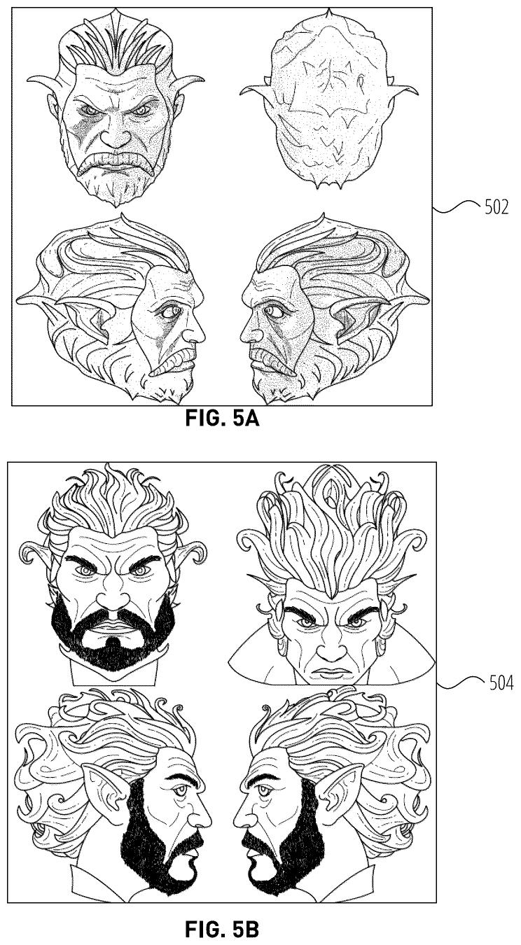

FIG. 5A illustrates example multiview global-space normal maps 502, according to some examples. The multiview global-space normal maps 502 provide view-independent color distributions by maintaining consistent normal vector orientations in a canonical coordinate system regardless of camera position. Unlike camera-space normal maps, these global-space normal maps show distinct color patterns that properly differentiate between front, side, and back views of a 3D asset. The normal vectors in global space maintain their orientation relative to the world coordinates rather than a camera position, allowing a system to generate more accurate and consistent texture representations. This approach helps prevent the Janus problem by providing unambiguous geometric information that distinguishes between different views of the object, particularly between frontal and side/back views

FIG. 5B illustrates example textures 504 generated using global-space normal maps, according to some examples. The textures 504 demonstrate proper texture generation without the unwanted additional faces that appear in camera-space normal map implementations. The texture 504 exhibit consistent representation across all views of the 3D head model, with appropriate facial features appearing only on the front view while the side and back views maintain their correct geometric appearance without duplicated facial features. This improved texture consistency is achieved because the global-space normal maps provide view-independent color distributions that properly differentiate between front, side, and back views of the 3D asset, allowing the machine learning model to generate textures that accurately reflect the intended geometry of each view

FIG. 6A illustrates an example machine model training method 600 and FIG. 6B illustrates a machine learning model training pipeline 148 provided by a content creation platform 104 (of FIG. 1), according to some examples. The machine learning model training pipeline 148 uses the machine model training method 600 to train a machine learning model 624 to generate output textures 626 used to generate renderings of 3D models. Although the example machine model training method 600 depicts a particular sequence of operations, the sequence may be altered without departing from the scope of the present disclosure. For example, some of the operations depicted may be performed in parallel or in a different sequence that does not materially affect the function of the machine model training method 600. In other examples, different components of a content creation platform 104 that implements the machine model training method 600 may perform functions at substantially the same time or in a specific sequence.

In operation 602, the machine learning model training pipeline 148 receives a set of 3D assets 614. For example, the machine learning model training pipeline 148 receives the plurality of 3D assets 614 through the content creation platform 104. The received 3D assets 614 can include mesh models and other 3D content that will be used to train the machine learning model 624. In some examples, the machine learning model training pipeline 148 receives the 3D assets 614 from a database of 3D models 128 (of FIG. 1) that stores various types of 3D assets used for generating content for XR applications. In additional examples, the machine learning model training pipeline 148 can receive the 3D assets 614 through an asset management component 126 (of FIG. 1) that handles importing, organizing and preparing the 3D assets 614 for the training process

In operation 604, the machine learning model training pipeline 148 generates a set of aligned 3D assets 640 by aligning each 3D asset of the set of 3D assets 614 to face a predefined direction. For example, the machine learning model training pipeline 148 uses an alignment filter component 616 to orient each 3D asset to face a consistent predefined direction. The alignment process ensures that when multiple 3D assets are placed together, they all face the same direction rather than being randomly rotated.

In some examples, alignment filter component 616 uses an automated alignment process. For example, the machine learning model training pipeline 148 can implement an automated alignment process that orients each 3D asset to face a consistent predefined direction. The automated alignment process analyzes geometric features of the 3D assets to determine their current orientation and applies transformations to align them to the target direction. In some examples, the automated alignment process uses feature detection algorithms to identify landmarks and reference points on the 3D assets that indicate their orientation. The machine learning model training pipeline 148 then calculates the necessary rotational transformations to orient these landmarks consistently across all assets in the training dataset. In additional examples, the automated alignment process employs computer vision techniques to detect facial features, anatomical landmarks, or geometric symmetries that can be used as reference points for alignment. The system applies these detected features to automatically rotate and position each 3D asset so that corresponding features across different 3D assets maintain consistent orientations relative to the global coordinate system.

In some examples, the alignment filter component 616 receives alignment instructions from a user and aligns each 3D asset of the set of 3D assets using the alignment instructions. The manual alignment process involves orienting each 3D asset to face a canonical direction to ensure consistent geometric relationships across a training dataset used to train the machine learning model 624.

In additional examples, the alignment filter component 616 performs the alignment of the 3D assets 614 by having a user review and adjust an orientation of each 3D asset of the set of 3D assets 614 to match a standardized reference direction. This manual alignment process, while more time-intensive than automated approaches, ensures the precise orientation needed for the global-space normal maps to properly differentiate between front, side, and back views during the training process

In operation 606, the machine learning model training pipeline 148 generates a set of multiview global-space normal maps 622 using the set of aligned 3D assets and a renderer. The set of multiview global-space normal maps 622 maintain consistent orientation independently of camera position. For example, the machine learning model training pipeline 148 uses a renderer 618 to generate a multiview global-space normal map for each aligned 3D asset of the set of aligned 3D assets 640. The global-space normal maps maintain consistent normal vector orientations in a canonical coordinate system regardless of camera position, allowing the machine learning model training pipeline 148 to properly differentiate between front, side, and back views of a 3D asset.

In some examples, the renderer 618 generates the multiview global-space normal maps 622 by maintaining normal vectors that point in consistent world-space directions rather than camera-relative directions. This approach ensures that corresponding geometric features across different views maintain consistent color patterns that uniquely identify their orientation in global space.

In additional examples, the renderer 618 generates the multiview global-space normal maps 622 by computing normal vectors that preserve their orientation relative to the world coordinates rather than a camera position. The system renders the multiview global-space normal maps 622 from multiple predefined viewing angles while ensuring that normal vectors for similar geometric features maintain consistent orientations across all views, enabling the machine learning model 624 to learn proper geometric relationships that prevent the Janus problem.

In some examples, the multiview global-space normal maps 502 provide view-independent color distributions that properly differentiate between front, side, and back views of the 3D assets 614. Unlike camera-space normal maps where color values remain constant regardless of actual orientation, the global-space normal maps show distinct color patterns for different views by maintaining normal vector orientations in a canonical coordinate system regardless of camera position.

In some examples, the renderer 618 generates the multiview global-space normal maps 622 by computing normal vectors that maintain their orientation relative to the world coordinates rather than camera position. The renderer 618 ensures that normal vectors for similar geometric features maintain consistent orientations in a canonical coordinate system across all views, enabling the machine learning model 624 to learn proper geometric relationships that prevent the Janus problem. Unlike camera-space normal maps where color values remain constant regardless of actual orientation, the multiview global-space normal maps 502 show distinct color patterns for different views by preserving normal vector orientations relative to the world coordinates. This consistent orientation in the canonical coordinate system allows generation of more accurate and consistent texture representations since the normal vectors maintain their spatial relationships independent of the viewing angle.

In some examples, the renderer 618 generates the multiview global-space normal maps 622 by rendering the normal maps from multiple predefined viewing angles of each aligned 3D asset. The system ensures consistent geometric representation across these different viewing angles by maintaining the normal vector orientations in the canonical coordinate system regardless of camera position.

In operation 608, machine model training method 600 generates, using the renderer 618 and the set of aligned 3D assets 640, a corresponding set of renders 620. For example, the machine learning model training pipeline 148 uses the renderer 618 to generate a corresponding render for each aligned 3D asset and multiview global-space normal map. The renders serve as ground truth data that will be used to train the machine learning model 624 to generate proper textures.

In some examples, the renders 620 are rendered in a Red Green Blue (RGB) color space. In additional examples, the renders 620 are rendered in a color space such as, but not limited to, Linear-sRGB, CIELAB (Lab*), CIELUV, OpenEXR, scRGB, normal map space, bump map space, specular map space, ambient occlusion map space, albedo map space, metalness map space, roughness map space, HDR color spaces, and the like.

In some examples, the renderer 618 generates the set of renders 620 using the same predefined viewing angles as the set of multiview global-space normal maps 622 to ensure proper correspondence between the conditioning input and the target output This allows the machine learning model training pipeline 148 to evaluate texture consistency across multiple views during the training process.

In additional examples, the renderer 618 generates high-quality renders that accurately capture the geometric and textural details of each aligned 3D asset. These renders provide the reference images that the machine learning model 624 will learn to reproduce when conditioned on the multiview global-space normal maps 622, enabling the machine learning model 624 to generate textures that properly reflect the intended appearance of the 3D assets across different viewing angles.

In some examples, the renderer 618 generates the renders 620 using the same predefined viewing angles that were used to generate the multiview global-space normal maps 622. This approach ensures proper correspondence between the conditioning input (global-space normal maps) and the ground truth data (renders) used to train the machine learning model 624. By maintaining consistent viewing angles between the multiview global-space normal maps 622 and renders 620, a model training system 638 can effectively evaluate how well the generated textures match the intended appearance from each specific view angle. This alignment of viewing angles is useful for preventing the Janus problem, as it allows the model training system 638 to properly train the model to generate appropriate textures for each distinct view while maintaining geometric consistency.

In operation 610, machine learning model training pipeline 148 trains the machine learning model 624 using the set of multiview global-space normal maps 622 as conditioning input and the set of renders 620 as ground truth, wherein training comprises applying loss backpropagation between output textures 626 generated by the machine learning model and the renders. For example, the machine learning model training pipeline 148 uses a model training system 638 that uses the multiview global-space normal maps 622 as conditioning input to train the machine learning model 624. The model training system 638 provides the renders 620 as ground truth data that the machine learning model 624 will learn to reproduce during training.

In some examples, the model training system 638 implements a loss function 634 that compares the output textures 626 generated by the machine learning model 624 against the ground truth renders 620. The loss function 634 generates a loss parameter 642 that quantifies the difference between the output textures 626 and the renders 620. The loss function 634 serves as a measure of the performance of the machine learning model 624 and guides the training process. The loss parameter 642 represents the degree of error in the output textures 626 generated by the machine learning model 624 and the model training system 638 attempts to minimize the loss parameter 642 by adjusting parameters of the machine learning model 624. The model training system 638 applies loss backpropagation to update the parameters of the machine learning model 624 based on the differences between the generated output textures 626 and the target renders 620.

In additional examples, the machine learning model training pipeline 148 iteratively trains the machine learning model 624 by conditioning the machine learning model 624 on both the set of global-space normal maps 622 and a set of prompts 628, generating output textures 626, comparing those outputs to the ground truth renders 620 using the loss function 634, and backpropagating the computed loss to optimize the model's ability to generate consistent textures that properly reflect the geometric features captured in the global-space normal maps.

In some examples, the prompts 628 can include text prompts that describe the desired output, such as descriptions of a texture to be generated. For example, when generating a penguin model, the model training system 638 uses text prompts describing the penguin's characteristics.

In some examples, prompts other than text prompts are used. Multiple types of prompts can be used for conditioning the machine learning model 624 to generate consistent textures for 3D assets. For example, for text-based prompting, the model training system 638 accepts descriptive prompts through a user interface to specify desired characteristics of the textures. In additional examples, for image-based prompting, the model training system 638 processes reference images to generate embeddings that are compatible with the machine learning model 624 architecture, allowing for personalized outputs based on exemplar images. In additional examples, for audio-based prompting, the model training system 638 can utilize audio inputs as prompts by processing audio signals to enable generation based on existing sounds rather than text descriptions.

In some examples, the machine learning model 624 is a diffusion model. Diffusion models are a class of generative machine learning models that simulate the process of gradually adding and then removing noise from data. They work by learning to reverse a diffusion process, starting with pure noise and progressively refining it into coherent data samples that resemble the training distribution. This approach allows diffusion models to generate high-quality, diverse outputs across various domains, including images, audio, and text. The process involves a forward diffusion step that adds noise to data and a reverse diffusion step that learns to denoise the data, enabling the model to generate new samples from random noise. Example diffusion models include, but are not limited to, Denoising Diffusion Probabilistic Models (DDPMs), Score-Based Generative Models, Latent Diffusion Models, Conditional Diffusion Models, Classifier-Free Guidance Models, Stable Diffusion Models, Guided Diffusion Models, Consistency Models, and the like.

In some examples, a ControlNet architecture is used for training the machine learning model 624 by using two neural network copies-a locked copy that preserves capabilities of an original model and a trainable copy that learns to generate textures based on global-space normal map conditioning. ControlNet introduces an additional layer of conditioning beyond text prompts used in text-to-image generation. This extra conditioning can take various forms, including, but not limited to, edge detection maps, pose estimations, segmentation maps, depth maps, scribble drawings, normal maps, and the like.

In some examples, the model training system 638 implements a loss function 634 that compares the output textures 626 generated by the machine learning model 624 against the ground truth renders 620 to evaluate texture consistency across multiple views. The model training system 638 evaluates how well the generated textures match the intended appearance from different viewing angles by comparing them to the corresponding renders that serve as ground truth. This comparison process helps ensure that the machine learning model 624 learns to generate textures that maintain consistent features and appearance when viewed from different angles, such as between front, side, and back views. The evaluation of texture consistency helps prevent the Janus problem, as such a loss function allows the model training system 638 to verify that facial features appear only on the front view and do not incorrectly manifest on the sides or back of a 3D asset.

In some examples, the 3D assets include mesh models. The renderer 618 generates the set of multiview global-space normal maps 622 and renders 620 for these mesh models while maintaining consistent orientation regardless of camera position. When generating output textures 626 from the mesh models, the trained machine learning model 624 produces consistent feature representations that properly reflect the geometric characteristics across different viewing angles. This consistency is achieved because the global-space normal maps provide view-independent color distributions that allow the machine learning model 624 to properly differentiate between front, side, and back views of the mesh models, preventing unwanted duplication of features like faces appearing on incorrect sides of a 3D asset texture mapped using the texture.

FIG. 7 illustrates a texture generation pipeline 130 for generating textures using a machine learning model trained using global-space normal maps, according to some examples. The texture generation pipeline 130 receives a 3D asset 702 that is processed through a series of components to generate an output texture 714. A renderer 706 processes the 3D asset to generate a render 708 of the 3D asset 702. A machine learning model 712 receives the render 708 from the renderer 706 and a prompt 716 as a conditioning input. The machine learning model 712, which has been trained as described above, generates the output texture 714 that exhibits proper geometric consistency across different views without the Janus problem of unwanted additional faces. The texture generation pipeline 130 demonstrates an application of the training process described above by using a trained machine learning model 712 to generate consistent textures based on global-space normal map conditioning. The texture can then be mapped to a 3D model to generate a rendered 3D asset.

In some examples, the prompt 716 can include a text prompt that describes a desired output, such as descriptions of the texture 406 to be generated. In some examples, a prompt other than a text prompt can be used as multiple types of prompts can be used for prompting the machine learning model 712 to generate consistent textures. For example, for text-based prompting, the model training system 638 accepts descriptive prompts through a user interface to specify desired characteristics of the textures. In additional examples, the prompt 716 can include an image for image-based prompting, allowing for personalized outputs based on exemplar images. In additional examples, for audio-based prompting, the prompt 716 can include audio data by processing audio signals to enable generation based on existing sounds rather than text descriptions.

Although described in the context of generating textures for texture mapping, it is to be understood that the methodologies described herein can be used for generating other types of 3D assets including, but not limited to, mesh models, rigged head models, animated avatars, 3D characters, and other virtual content for XR applications. The methodologies can be applied to generate consistent textures and geometric features across different types of 3D assets while maintaining proper view-dependent representations and avoiding unwanted artifacts similar to the Janus problem.

Described implementations of the subject matter can include one or more features, alone or in combination as illustrated below by way of example.

Example 1 is a machine-implemented method, comprising: receiving a set of three-dimensional (3D) assets; generating a set of aligned 3D assets by aligning each 3D asset of the set of 3D assets to face a predefined direction; generating a set of multiview global-space normal maps that maintain consistent orientation independently of camera position using a renderer and the set of aligned 3D assets; generating a corresponding set of renders using the renderer and the set of 3D assets; and training a machine learning model to generate output textures using the multiview global-space normal maps a set of prompts as conditioning input and the set of renders as ground truth, the training including applying loss backpropagation between the output textures generated by the machine learning model and respective renders of the set of renders.

In Example 2, the subject matter of Example 1 includes, wherein a set of prompts are used as an additional conditioning input.

In Example 3, the subject matter of any of Examples 1-2 includes, wherein generating the multiview global-space normal maps comprises generating the set global-space normal maps for multiple predefined viewing angles of the set of 3D assets.

In Example 4, the subject matter of any of Examples 1-3 includes, wherein generating the set of multiview global-space normal maps comprises maintaining normal vector orientations in a canonical coordinate system regardless of camera positioning.

In Example 5, the subject matter of any of Examples 1-4 includes, wherein the set of 3D assets comprise mesh models, and wherein the output textures provide consistent feature representation across different viewing angles.

In Example 6, the subject matter of any of Examples 1-5 includes, wherein training the machine learning model further comprises comparing the output textures to respective renders of the set of renders to evaluate texture consistency across multiple views.

In Example 7, the subject matter of any of Examples 1-6 includes, further comprising applying the trained machine learning model to generate textures for new 3D assets using a prompt as conditioning input.

In Example 8, the subject matter of any of Examples 1-7 includes, wherein the set of renders are generated using a same predefined viewing angle as the multiview global-space normal maps.

In Example 9, the subject matter of any of Examples 1-8 includes, D assets using a prompt as conditioning input.

Example 10 is at least one machine-readable medium including instructions that, when executed by processing circuitry, cause the processing circuitry to perform operations to implement any of Examples 1-9.

Example 11 is an apparatus comprising means to implement any of Examples 1-9.

Example 12 is a system to implement any of Examples 1-9.

Example 13 is a method to implement any of Examples 1-9.

### GLOSSARY

“Carrier signal” refers to any intangible medium that is capable of storing, encoding, or carrying instructions for execution by the machine and includes digital or analog communications signals or other intangible media to facilitate communication of such instructions. Instructions may be transmitted or received over a network using a transmission medium via a network interface device.

“Communication network” refers to one or more portions of a network that may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, a network or a portion of a network may include a wireless or cellular network, and the coupling may be a Code Division Multiple Access (CDMA) connection, a Global System for Mobile communications (GSM) connection, or other types of cellular or wireless coupling. In this example, the coupling may implement any of a variety of types of data transfer technology, such as Single Carrier Radio Transmission Technology (1xRTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth-generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long-range protocols, or other data transfer technology.

“Component” refers to a device, physical entity, or logic having boundaries defined by function or subroutine calls, branch points, APIs, or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components. A “hardware component” is a tangible unit capable of performing certain operations and may be configured or arranged in a certain physical manner. In various examples, one or more computer systems (e.g., a standalone computer system, a client computer system, or a server computer system) or one or more hardware components of a computer system (e.g., a processor or a group of processors) may be configured by software (e.g., an application or application portion) as a hardware component that operates to perform certain operations as described herein. A hardware component may also be implemented mechanically, electronically, or any suitable combination thereof. For example, a hardware component may include dedicated circuitry or logic that is permanently configured to perform certain operations. A hardware component may be a special-purpose processor, such as a field-programmable gate array (FPGA) or an application-specific integrated circuit (ASIC). A hardware component may also include programmable logic or circuitry that is temporarily configured by software to perform certain operations. For example, a hardware component may include software executed by a general-purpose processor or other programmable processors. Once configured by such software, hardware components become specific machines (or specific components of a machine) uniquely tailored to perform the configured functions and are no longer general-purpose processors. It will be appreciated that the decision to implement a hardware component mechanically, in dedicated and permanently configured circuitry, or in temporarily configured circuitry (e.g., configured by software), may be driven by cost and time considerations. Accordingly, the phrase “hardware component”(or “hardware-implemented component”) should be understood to encompass a tangible entity, be that an entity that is physically constructed, permanently configured (e.g., hardwired), or temporarily configured (e.g., programmed) to operate in a certain manner or to perform certain operations described herein. Considering examples in which hardware components are temporarily configured (e.g., programmed), each of the hardware components need not be configured or instantiated at any one instance in time. For example, where a hardware component comprises a general-purpose processor configured by software to become a special-purpose processor, the general-purpose processor may be configured as respectively different special-purpose processors (e.g., comprising different hardware components) at different times. Software accordingly configures a particular processor or processors, for example, to constitute a particular hardware component at one instance of time and to constitute a different hardware component at a different instance of time. Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses) between or among two or more of the hardware components. In examples in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information). The various operations of example methods described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions described herein. As used herein, “processor-implemented component” refers to a hardware component implemented using one or more processors. Similarly, the methods described herein may be at least partially processor-implemented, with a particular processor or processors being an example of hardware. For example, at least some of the operations of a method may be performed by one or more processors or processor-implemented components. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an API). The performance of certain of the operations may be distributed among the processors, not only residing within a single machine, but deployed across a number of machines. In some examples, the processors or processor-implemented components may be located in a single geographic location (e.g., within a home environment, an office environment, or a server farm). In other examples, the processors or processor-implemented components may be distributed across a number of geographic locations.

“Machine-storage medium” refers to a single or multiple storage devices and media that store executable instructions, routines and data. The term shall accordingly be taken to include, but not be limited to, solid-state memories, and optical and magnetic media, including memory internal or external to processors. Specific examples of machine-storage media include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks. The terms “machine-storage medium,” “device-storage medium,” and “computer-storage medium” mean the same thing and may be used interchangeably in this disclosure. The terms “machine-storage medium,” “computer-storage medium,” and “device-storage medium” specifically exclude carrier waves, modulated data signals, and other such media, at least some of which are covered under the term “signal medium.”

“Machine-readable storage medium” refers to both machine-storage media and transmission media. Thus, the term “machine-readable storage medium” includes both storage devices/media and carrier waves/modulated data signals. The terms “computer-readable storage medium,” “machine-readable storage medium,” and “device-readable storage medium” mean the same thing and may be used interchangeably in this disclosure.

“Non-transitory machine-readable storage medium” excludes carrier waves, modulated data signals, and other such media, at least some of which are covered under the term “signal medium.” The terms “non-transitory machine-readable storage medium,” “non-transitory device-readable storage medium,” and “non-transitory computer-readable storage medium” mean the same thing and may be used interchangeably in this disclosure.

“Signal medium” refers to any intangible medium that is capable of storing, encoding, or carrying the instructions for execution by a machine and includes digital or analog communications signals or other intangible media to facilitate communication of software or data. The term “signal medium” shall be taken to include any form of a modulated data signal, carrier wave, and so forth. The term “modulated data signal” means a signal that has one or more of its characteristics set or changed in such a matter as to encode information in the signal. The terms “transmission medium” and “signal medium” mean the same thing and may be used interchangeably in this disclosure.

Changes and modifications may be made to the disclosed examples without departing from the scope of the present disclosure. These and other changes or modifications are intended to be included within the scope of the present disclosure, as expressed in the following claims.

What is claimed is:

1. A machine-implemented method, comprising:
receiving a set of three-dimensional (3D) assets;
generating a set of aligned 3D assets by aligning each 3D asset of the set of 3D assets to face a predefined direction;
generating a set of multiview global-space normal maps that maintain consistent orientation independently of camera position using the set of aligned 3D assets;
generating a corresponding set of renders using the set of aligned 3D assets; and
training a machine learning model to generate output textures using the multiview global-space normal maps as conditioning input and the set of renders as ground truth, the training including applying loss backpropagation between the output textures generated by the machine learning model and respective renders of the set of renders.

2. The machine-implemented method of claim 1, wherein the set of multiview global-space normal maps provide respective view-independent color distributions that differentiate between front, side, and back views of the set of 3D assets.

3. The machine-implemented method of claim 1, wherein generating the set of multiview global-space normal maps comprises maintaining normal vector orientations in a canonical coordinate system regardless of camera positioning.

4. The machine-implemented method of claim 1, wherein generating the multiview global-space normal maps comprises generating the set of multiview global-space normal maps for multiple predefined viewing angles of the set of 3D assets.

5. The machine-implemented method of claim 1, wherein the set of 3D assets comprise mesh models, and wherein the output textures provide consistent feature representation across different viewing angles.

6. The machine-implemented method of claim 1, wherein the set of renders are generated using a same predefined viewing angle as the multiview global-space normal maps.

7. The machine-implemented method of claim 1, further comprising applying the trained machine learning model to generate textures for new 3D assets using a prompt as conditioning input.

8. A machine comprising:
one or more processors; and
a memory storing instructions that, when executed by the one or more processors, cause the machine to perform operations comprising:
receiving a set of three-dimensional (3D) assets;
generating a set of aligned 3D assets by aligning each 3D asset of the set of 3D assets to face a predefined direction;
generating a set of multiview global-space normal maps that maintain consistent orientation independently of camera position using the set of aligned 3D assets;
generating a corresponding set of renders using the set of aligned 3D assets; and
training a machine learning model to generate output textures using the multiview global-space normal maps as conditioning input and the set of renders as ground truth, the training including applying loss backpropagation between the output textures generated by the machine learning model and respective renders of the set of renders.

9. The computing apparatus of claim 8, wherein the set of multiview global-space normal maps provide respective view-independent color distributions that differentiate between front, side, and back views of the set of 3D assets.

10. The computing apparatus of claim 8, wherein generating the set of multiview global-space normal maps comprises maintaining normal vector orientations in a canonical coordinate system regardless of camera positioning.

11. The computing apparatus of claim 8, wherein generating the multiview global-space normal maps comprises generating the set of multiview global-space normal maps for multiple predefined viewing angles of the set of 3D assets.

12. The computing apparatus of claim 8, wherein the set of 3D assets comprise mesh models, and wherein the output textures provide consistent feature representation across different viewing angles.

13. The computing apparatus of claim 8, wherein the set of renders are generated using a same predefined viewing angle as the multiview global-space normal maps.

14. The computing apparatus of claim 8, wherein the operations further comprise applying the trained machine learning model to generate textures for new 3D assets using a prompt as conditioning input.

15. A computer-storage medium including instructions that when executed by a computer, cause the computer to perform operations comprising:
receiving a set of three-dimensional (3D) assets;
generating a set of aligned 3D assets by aligning each 3D asset of the set of 3D assets to face a predefined direction;
generating a set of multiview global-space normal maps that maintain consistent orientation independently of camera position using the set of aligned 3D assets;
generating a corresponding set of renders using the set of aligned 3D assets; and
training a machine learning model to generate output textures using the multiview global-space normal maps as conditioning input and the set of renders as ground truth, the training including applying loss backpropagation between the output textures generated by the machine learning model and respective renders of the set of renders.

16. The computer-readable medium of claim 15, wherein the set of multiview global-space normal maps provide respective view-independent color distributions that differentiate between front, side, and back views of the set of 3D assets.

17. The computer-readable medium of claim 15, wherein generating the set of multiview global-space normal maps comprises maintaining normal vector orientations in a canonical coordinate system regardless of camera positioning.

18. The computer-readable medium of claim 15, wherein generating the multiview global-space normal maps comprises generating the set of multiview global-space normal maps for multiple predefined viewing angles of the set of 3D assets.

19. The computer-readable medium of claim 15, wherein the set of 3D assets comprise mesh models, and wherein the output textures provide consistent feature representation across different viewing angles.

20. The computer-readable medium of claim 15, wherein the set of renders are generated using a same predefined viewing angle as the multiview global-space normal maps.
